(19) United States
(12) Patent Application Publication
(10) Pub. No.: US 2017/0027096 A1
(43) Pub. Date: Feb. 2, 2017

(54) ADJUSTABLE SHOVEL

(71) Applicant: Roger Smith, Merrillville, IN (US)

(72) Inventor: Roger Smith, Merrillville, IN (US)

(21) Appl. No.: 14/811,694

(22) Filed: Jul. 28, 2015

(51) Int. Cl. A01B 1/02; E01H 5/02

(52) U.S. Cl. CPC A01B 1/022; E01H 5/02

(57) ABSTRACT

The present invention provides users with a fully adjustable shovel to move different quantities of debris, dirt, snow, and the like. The invention comprises a blade that can be expanded in length and width. The invention affords the user with a shovel device that can be adjusted to different sizes in order to accommodate various tasks and materials.

### DETAILED DESCRIPTION OF INVENTION

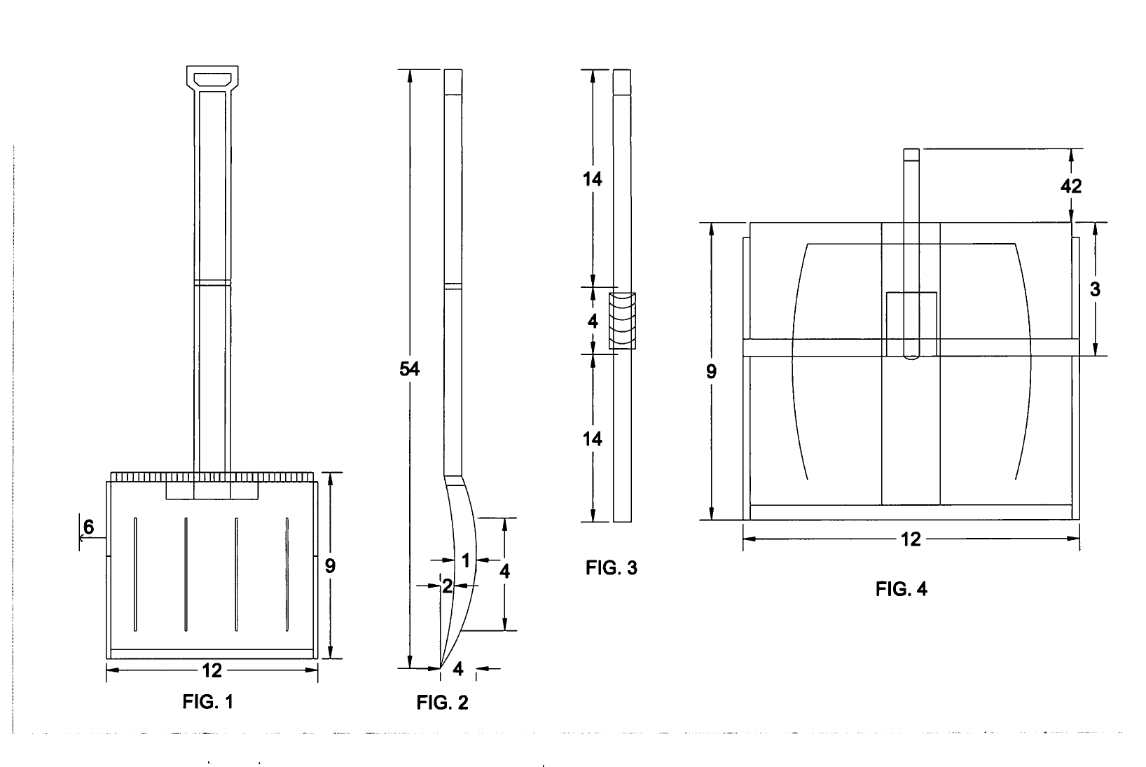

Referring now to FIG. 1, there is shown a front view of the present invention with a telescopic handle. The present invention provides an apparatus that comprises an adjustable shaft and blade. The blade can expand in both length and width in order to coincide with a specific task. The invention is intended to create an efficient tool that can enable the user to decrease the amount of time required to complete a job.

Referring now to FIG. 2, there is shown a side view of the present invention with a rubber grip handle portion. The invention comprises an. The item can be made of a plastic material or other suitable material and the device in its entirety can be constructed from durable, long lasting and weatherproof materials.

Referring now to FIGS. 3, 4, and 5 there is shown a front view, a top view and a side view of the blade portion of the present invention. The present invention provides a shovel apparatus that includes a handle connected to a telescopic shaft wherein the telescopic shaft is attached to the adjustable blade of the device. The adjustable blade makes it easier for a user to pick up debris such as snow, leaves, dirt and the like by allowing the user to change the height and length of the blade to suit the different amounts of debris needed to be collected and/or moved. This enables the user to employ one device rather than utilize different types of shovels for different jobs such as gardening, clearing snow, moving soil and the like.

Referring now to FIG. 6, there is shown a view of the telescopic handle of the present invention. The present invention allows a user to adjust the handle and blade of the device. The blade can expand in width and length, while the handle can expand in length. The blade of the device is connected to a telescopic shaft that is further connected to the handle via rivets or other suitable connecting means. The device allows users of all sizes to easily use the device for various tasks wherein the device is lightweight and easily maneuvered.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

Since the main purpose of the invention is to provide the operator(s) of the shovel with the ability to change the working area of the scoop on the shovel a more technical description is being provided here in this document.

The technical discussion for this request for a patent will be centered around some of the physical layouts of the shovel. Following are the four (4) areas of discussion: 1) the shovel's full front view, 2) the shovel's full side view, 3) the shovel's full shaft's view (without the blade), and 4) the shovel's full rear view with a partial shaft view.

First of all, know that this device looks very much like most other types of shovels, e.g., for instance, this view might be a full front view of a shovel that's used to remove snow. Refer to FIGS. 1, 2, 3 and 4 below in this drawing section.

FIG. 1 The Shovel's Front View.
In this view one sees the adjustable shovel in a full front view. One also sees one (1) fixed main blade view that measures 12″×9″ along with two (2) other auxiliary 6″×9″ blades that are attached (invisibly) to the backside of the main central blade. Note 1: None of the measurements in this detailed description of the adjustable shovel invention is to scale. Note 2: All shovel blades in this drawing are made of a lightweight metal that has superior lifting strength for heavy loads. This main blade is attached to a durable material shaft that measures 45″.
The thing that makes this adjustable shovel so unique is its ability to select (optionally) either the left auxiliary blade or the right auxiliary blade or both auxiliary blades and then move them in or out either 50% or 100% mark. If the operator choses the 50% Mark, then the total fixed horizontal length of the blades will be 18″ regardless of which auxiliary blade is chosen. However, if the operator selects the 100% marking of both auxiliary blades, then the total horizontal length of the blades will measure 24″.

FIG. 2 The Shovel's Full Shaft View (with the Blade).
This view of the Adjustable Shovel shows the two (2) main vertical portions of the shovel after it has been rotated 90° in a clockwise position with respect to the position of the shovel as it is shown in FIG. 1. One can now easily see that this view of the adjustable shovel allows one to see the normalized view of the shovel's blade along with the shovel's circular view of its telescopic shaft. It should also be noted here that the vertical height of the shovel is 9″ and that the full horizontal outer width of the shovel's blade encompasses 4″ horizontally from the tip of the blade to the junction where the blade meets the shaft, thereby creating a radius of curvature (2, 4).
It should be also noted here that the full length of telescopic shaft in this invention is 45″ and that there are three (3) telescopic sections of this device, each of which is capable of expanding vertically into an adjacent section of the shaft 10″, thereby providing a safety factor when the telescopic function is used. Note: Each section of this invention has a shaft that is capable of its own telescopic use.

FIG. 3 Full View of the Telescopic Shaft
The circular shaft has three (3) continuous telescopic sections whereby each section measures 14″ in length. The circular shaft measure 42″ in total length and is 1″ in diameter. The circular shaft measurement in the vertical direction is a total of 54″. The circular shaft is connected to a handle at the top end of the shaft and is connected to the shovel's metallic scoop at the bottom end of the circular shaft. This circular shaft can be made up of plastic materials and/or other suitable materials, such as, those materials that are durable, long lasting and weatherproof.
   This telescopic shaft will afford operators of different physical heights to easily use the adjustable shovel. When an operator wants to extend any of the 3 telescopic shafts the maximum insertion into an adjacent shaft will be 10″. By limiting the maximum shaft insertion point to 10″ this will allow for 2″ of sturdiness of the shovel's fulcrum; thereby increasing the safety aspect of the circular telescopic shaft. Finally, this device allows users of all sizes to easily use this telescopic device for various tasks because the device is lightweight and easily maneuvered.

FIG. 4. Detail description of the invention
Note: It is easy to see on FIG. 4 as well as the other figures above in this document that none of the drawings are to scale.

In the FIG. 4 drawing one can easily see the there is a small stub showing above the full rear view drawing of the rear view shovel blade. The physical dimensions of the full rear view of the shovel shows that the horizontal dimensions of the shovel are 12″.

These 12″ represent the horizontal left and right moving panels. The physical measurements of these two (2) horizontal moving panels are identical, in that each panel measures 6″×9″. One of the most important features of these moving panels is that the operator has complete control in moving each panel independently of the other panel. Also, note that the operator of the shovel can move the panels independently/horizontally of the other panel and can extend them to either a half-extended mode range of 3″ (aka the 25% mode range) or move them to a fully-extended mode range of 6″ (aka 50% mode range). In essence, the adjustable shovel invention has six (6) positions.

1. A shovel consisting of:
A shovel blade which adjusts to specifications determined in order to increase (or eventually decrease), the blade surface for lifting debris, etc.
